(19) United States
(12) Patent Application Publication
(10) Pub. No.: US 2018/0253728 A1
(43) Pub. Date: Sep. 6, 2018

(54) OPTIMIZING FRAUD ANALYTICS SELECTION

(71) Applicant: International Business Machines Corporation, Armonk, NY (US)

(72) Inventors: Thomas T. Hanis, Raleigh, NC (US); Willie R. Patten, JR., Hurdle Mills, NC (US)

(21) Appl. No.: 15/447,453

(22) Filed: Mar. 2, 2017

(51) Int. Cl. G06Q 20/40

(52) U.S. Cl. CPC G06Q 20/4016

(57) ABSTRACT

A computer-implemented method, system, and computer program product for optimizing analytics selection to detect fraud retrieves, from an electronic database, historical data on a plurality of available fraud detection analytics, the historical data including service times and risk levels associated with the fraud detection analytics, and analyzes the historical data to form a fraud detection analytics optimization model. A required service time for the transaction is determined based on information about the requester and the transaction, and the fraud detection analytics optimization model is used to select, from a plurality of available fraud detection analytics, a fraud detection analytic with a lowest risk level predicted to execute within the required service time. The selected fraud detection analytic is applied to the transaction to obtain an indication of risk, such as a risk score, which may be communicated to the requester and/or a computer-implemented process for approving or disapproving the transaction.

### BACKGROUND

### 1. Technical Field

Present invention embodiments relate to computer systems and methods for optimizing analytics selection to detect fraud.

### 2. Discussion of the Related Art

Determining fraud risk involves the collection of data and the execution of one or more fraud analytics against that data in order to assess the risk. Fraud analytics range from simple to complex. For example, simple analytics may be based on transaction amount, transaction location, and transaction type. More complicated analytics may be based on factors like deviations from individualized transaction patterns established over time, evolving fraud patterns, and deeply nested relationship analysis of the transaction requestor.

Simple analytics tend to execute very quickly, operating primarily on the data in the transaction request and profile information, while more complicated fraud analytics tend to be much longer running (perhaps designed with offline/batch operation in mind), relying on a range of data used for comparison, anomaly, association and trend analysis.

In general, use of more complicated analytics can lead to more complete and accurate risk assessments. However, more complicated analytics generally require more resources and capacity. That is, more complicated analytics generally require more data, more historical analysis, and more capacity to execute the requested assessment.

Fraud detection systems are often governed by a service level agreement (“SLA”) that establishes guaranteed response times. The SLA may also specify the fraud analytics to be used for specific operational flows in the system. That is, the type of analytic used for each type of transaction is predetermined and fixed.

### SUMMARY

According to an example embodiment of the present invention, a computer-implemented method for optimizing analytics selection to detect fraud comprises retrieving, from an electronic database, historical data on a plurality of available fraud detection analytics, the historical data including service times and risk levels associated with the fraud detection analytics; analyzing the historical data to form a fraud detection analytics optimization model; receiving, from a requester via an electronic communications network, a request to analyze a first transaction, the request including information about the first transaction; determining, based on the requester and information about the first transaction, a required service time for the first transaction; using the fraud detection analytics optimization model to select, from the plurality of available fraud detection analytics, a fraud detection analytic with a lowest risk level predicted to execute within the required service time; applying the selected fraud detection analytic to the first transaction to obtain an indication of risk, such as a risk score; and reporting, to the requester via the electronic communications network, the indication of risk for the first transaction. In an example embodiment, the historical data may further include resource consumption associated with the fraud detection analytics, and the fraud detection analytics optimization model may be configured to take into account the historical data on resource consumption and current system resources when selecting a fraud detection analytic for the first transaction. In an example embodiment, the method may further include retrieving, from an electronic database, a service level agreement model associated with the requester, and applying the service level agreement model to the first transaction to determine a required service time and/or available fraud analytics for the first transaction. In an example embodiment, the method may further include measuring a service time associated with applying the selected fraud detection analytic to the first transaction, updating the historical data based on the measured service time, and updating the fraud detection analytics optimization model based on the updated historical data.

According to another example embodiment of the present invention, a system for optimizing analytics selection to detect fraud comprises at least one processor configured to retrieve, from an electronic database, historical data on a plurality of available fraud detection analytics, the historical data including service times and risk levels associated with the fraud detection analytics; analyze the historical data to form a fraud detection analytics optimization model; receive, from a requester via an electronic communications network, a request to analyze a first transaction, the request including information about the first transaction; determine, based on the requester and information about the first transaction, a required service time for the first transaction; use the fraud detection analytics optimization model to select, from the plurality of available fraud detection analytics, a fraud detection analytic with a lowest risk level predicted to execute within the required service time; apply the selected fraud detection analytic to the first transaction to obtain an indication of risk, such as a risk score; and report, to the requester via the electronic communications network, the indication of risk for the first transaction. In an example embodiment, the historical data may further include resource consumption associated with the fraud detection analytics, and the processor is configured to take into account the historical data on resource consumption and current system resources when selecting a fraud detection analytic for the first transaction. In an example embodiment, the processor may be configured to retrieve, from an electronic database, a service level agreement model associated with the requester, and to apply the service level agreement model to the first transaction to determine a required service time and/or available fraud analytics for the first transaction. In an example embodiment, the processor may be configured to measure a service time associated with applying the selected fraud detection analytic to the first transaction, to update the historical data based on the measured service time, and to update the fraud detection analytics optimization model based on the updated historical data.

According to yet another example embodiment of the present invention, a computer program product for optimizing analytics selection to detect fraud comprises a computer readable storage medium having program instructions embodied therewith, the program instructions executable by a computer processor to cause the computer processor to retrieve, from an electronic database, historical data on a plurality of available fraud detection analytics, the historical data including service times and risk levels associated with the fraud detection analytics; analyze the historical data to form a fraud detection analytics optimization model; receive, from a requester via an electronic communications network, a request to analyze a first transaction, the request including information about the first transaction; determine, based on the requester and information about the first transaction, a required service time for the first transaction; use the fraud detection analytics optimization model to select, from the plurality of available fraud detection analytics, a fraud detection analytic with a lowest risk level predicted to execute within the required service time; apply the selected fraud detection analytic to the first transaction to obtain an indication of risk, such as a risk score; and report, to the requester via the electronic communications network, the indication of risk for the first transaction. In an example embodiment, the historical data further includes resource consumption associated with the fraud detection analytics, and wherein the fraud detection analytics optimization model is configured to take into account the historical data on resource consumption and current system resources when selecting a fraud detection analytic for the first transaction. In an example embodiment, the program instructions are executable by a computer processor to cause the computer processor to retrieve, from an electronic database, a service level agreement model associated with the requester, and to apply the service level agreement model to the first transaction to determine a required service time and/or available fraud analytics for the first transaction. In an example embodiment, the program instructions are executable by a computer processor to cause the computer processor to measure a service time associated with applying the selected fraud detection analytic to the first transaction, to update the historical data based on the measured service time, and to update the fraud detection analytics optimization model based on the updated historical data.

### BRIEF DESCRIPTION OF THE DRAWINGS

Generally, like reference numerals in the various figures are utilized to designate like components.

FIG. 1 is a diagrammatic illustration of an example computing environment implementing an embodiment of the present invention.

FIG. 2 is a diagrammatic illustration of an analytic optimization module according to an example embodiment of the present invention.

FIG. 3 is a procedural flowchart illustrating a manner of detecting fraud according to an example embodiment of the present invention.

### DETAILED DESCRIPTION

Present invention embodiments can provide a more accurate risk analysis while meeting guaranteed response times and making more efficient use of computing resources by applying one or more models in real-time against targeted response time criteria, available system resources, historical analytics statistics, and available data to select an optimal fraud analytic for use in the analysis. The models may be configured to adapt in real time and tie directly into the analytics flow selection processing in order to provide such optimization.

Present invention embodiments may maintain a pre-defined list or register of analytics that may be used to perform fraud detection analyses based on the type of data available (e.g., “run analysis A, B or C if the data is pertaining to accounts”, “run analysis X, Y or Z if the data is pertaining to transactions”, etc.). The analytics may comprise any type of fraud model or algorithm, such as deterministic or rule-based algorithms, scoring models, or regression models. Deterministic or rule-based algorithms are generally the least complex type of fraud analytic and generally require the least amount of processing resources and time to execute. Scoring models are generally more complex than deterministic or rule-based algorithms and generally require more processing resources and time to execute, and regression models are generally an even more complex type of fraud analytic and generally require more processing resources and time to execute than the other two types of analytics. Less complex fraud analytics are generally more risky (i.e., more likely to provide a false result), whereas more complex fraud analytics are generally less risky (i.e., less likely to provide a false result).

Present invention embodiments may maintain runtime facts about each fraud detection analysis, such as the analytic(s) used, the amount of data analyzed, the amount of time spent on the analysis, the amount of system resources used, and other runtime statistics regarding the data and analysis run against the data.

Present invention embodiments may utilize an agent on the runtime environment to provide details on the current load and overall availability of computing resources in the environment. An agent may also be used to maintain runtime facts about each fraud detection analysis conducted.

When new data arrives, present invention embodiments may compare the data against the pre-defined list that specifies a set of available fraud analytics that could be run based on the data. Given a set of fraud analytics that could be run against the data, present invention embodiments may determine the current environmental load and use the combination of historical execution times with the current machine load, compared against the required SLA, to determine the “optimal” or “best” set of analytics to run to detect potential fraud.

In order to optimize the selection of analytics to be run, present invention embodiments may apply an optimization model against a set of models, such as a service level agreement model, an execution history model, a current system load model, and an operational data model (also referred to herein as a “data types and extent model”).

For example, the service level agreement model may provide information about response time requirements, available analytics by data type, and any additional qualifications that could affect the run time target such as time of day, day of week, or any other factors. An example execution history model may maintain current and historical statistics on analytics execution times including maintaining relevant information on resource consumption. The execution history model may also be responsible for analytics execution time estimation and projection. An example current system load model may maintain information on system capacity—e.g., memory and CPU utilization and availability—and may also be responsible to provide a real time capacity assessment. An example operational data model may maintain information on business application data, e.g., as meta-data that reflects the type, extent, and breadth of the business data as it is loaded into the system. In some applications, optimized analytics selection may be initiated as a result of data ingestion.

Present invention embodiments may include an analytics operational model (also referred to herein as an “analytics optimization model”) that connects other models. In an example embodiment, the analytics operational model may be an application of a layered model on the other models to manage information flow. The analytics operational model may provide a mapping from the analytics request to the execution of the optimized fraud analytics selection process that provides the best operational accuracy within a set of parameters or constraints that may include target response time, availability of system resources needed for execution, and data availability. The optimized fraud analytics selection process according to present invention embodiments may occur in real time and may be managed in a changing environment with potentially adapting business needs.

Present invention embodiments may ensure use of the most complete and accurate fraud analytics available, given a current set of computer resources, available data, and response time constraints.

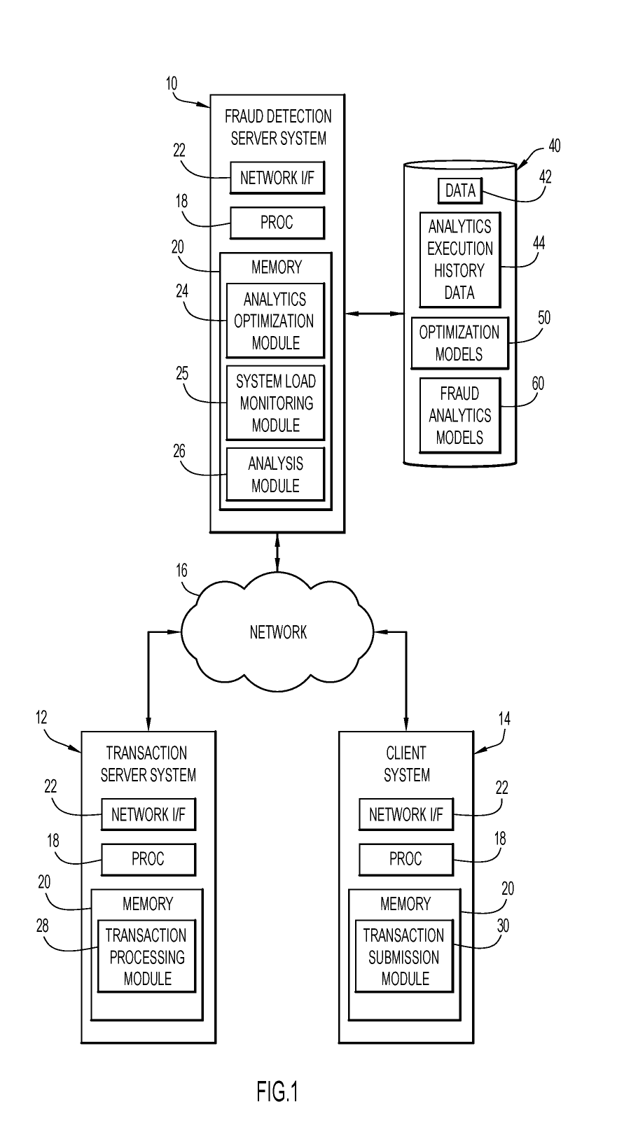

An example environment for use with present invention embodiments is illustrated in FIG. 1. Specifically, the environment includes one or more fraud analytics server systems 10, one or more transaction server systems 12, and one or more client systems 14. Server systems 10, 12 and client systems 14 may be remote from each other and communicate over an electronic communications network 16.

Server systems 10, 12 and client systems 14 may be implemented by any conventional or other computer systems preferably equipped with a display or monitor, a base (e.g., including at least one processor 18, one or more memories 20 and/or internal or external network interfaces or communications devices 22 (e.g., modem, network cards, etc.)), optional input devices (e.g., a keyboard, mouse or other input device), any commercially available software (e.g., server/communications software, browser/interface software, etc.), and any custom software (e.g., modules 24, 25, 26, 28, and 30 discussed herein, etc.). The network 16 may be implemented by any number of any suitable communications media (e.g., wide area network (WAN), local area network (LAN), Internet, Intranet, etc.). Alternatively, at least some of server systems 10, 12 and at least some of the client systems 14 may be local to each other, and communicate via any appropriate local communication medium (e.g., local area network (LAN), hardwire, wireless link, Intranet, etc.).

In an example embodiment, server systems 10 may include an analytics optimization module 24 to receive information about a transaction and select one or more fraud analytics, a system load monitoring module 25 to obtain information on system capacity (e.g., memory and CPU utilization), and an analysis module 26 to analyze the transaction using the one or more fraud analytics and to communicate the results. Modules 24, 25 and 26 may be combined into a single module. Alternatively, modules 24, 25 and 26 may be separate as shown, and it will be appreciated that one of more of the modules may each include one or more modules or units to perform the various functions of present invention embodiments described below. It will also be appreciated that present invention embodiments may be embedded into and/or coupled with current fraud detection systems.

A database system 40 may store SLA data 42 describing SLAs with one or more clients, analytics execution history data 44, optimization models 50, fraud analytics 60, and various other types of information (e.g., user account information, etc.). The database system 40 may be implemented by any conventional or other database or storage unit, may be local to or remote from server systems 10, and may communicate via any appropriate communication medium (e.g., local area network (LAN), wide area network (WAN), Internet, hardwire, wireless link, Intranet, etc.).

Server systems 12 may include a transaction processing module 28 to receive information about a transaction from a client system 14, initiate a fraud analysis at server system 10, and communicate a fraud analysis result to client system 14. While a single module 28 is shown, it will be appreciated that the module may include multiple modules or units to perform the various functions of present invention embodiments described below. The various modules of server systems 12 may be implemented by any combination of any quantity of software and/or hardware modules or units, and may reside within memory 20 of the server systems 12 for execution by processor 18 of the server systems 12. Alternatively, the module 28 may reside within memory 20 of the server systems 10 for execution by processor 18 of the server systems 10.

Client systems 14 may be configured to submit a transaction for processing and receive a fraud analysis result by use of a transaction submission module 30. While a single module 30 is shown, it will be appreciated that the module may include multiple modules or units to perform the various functions of present invention embodiments described below. The various modules of client systems 14 may be implemented by any combination of any quantity of software and/or hardware modules or units, and may reside within memory 20 of the client systems 14 for execution by processor 18 of the client systems 14. Alternatively, a client system 14 may be a thin client, and the module 30 may reside within memory 20 of the server systems 10 or 12 for execution by processor 18 of the server systems when accessed by client system 14.

The client systems 14 may present a graphical user interface (e.g., GUI, etc.) or other interface (e.g., command line prompts, menu screens, etc.) on a monitor or screen to display information (e.g., transaction processing status, fraud detection result, request for information, instructions, etc.) and/or to accept input from users (e.g., information about the transaction, commands, inquiries, etc.). Client systems 14 may include other types of user input devices, such as a keyboard, a touch pad, etc., to accept input from users.

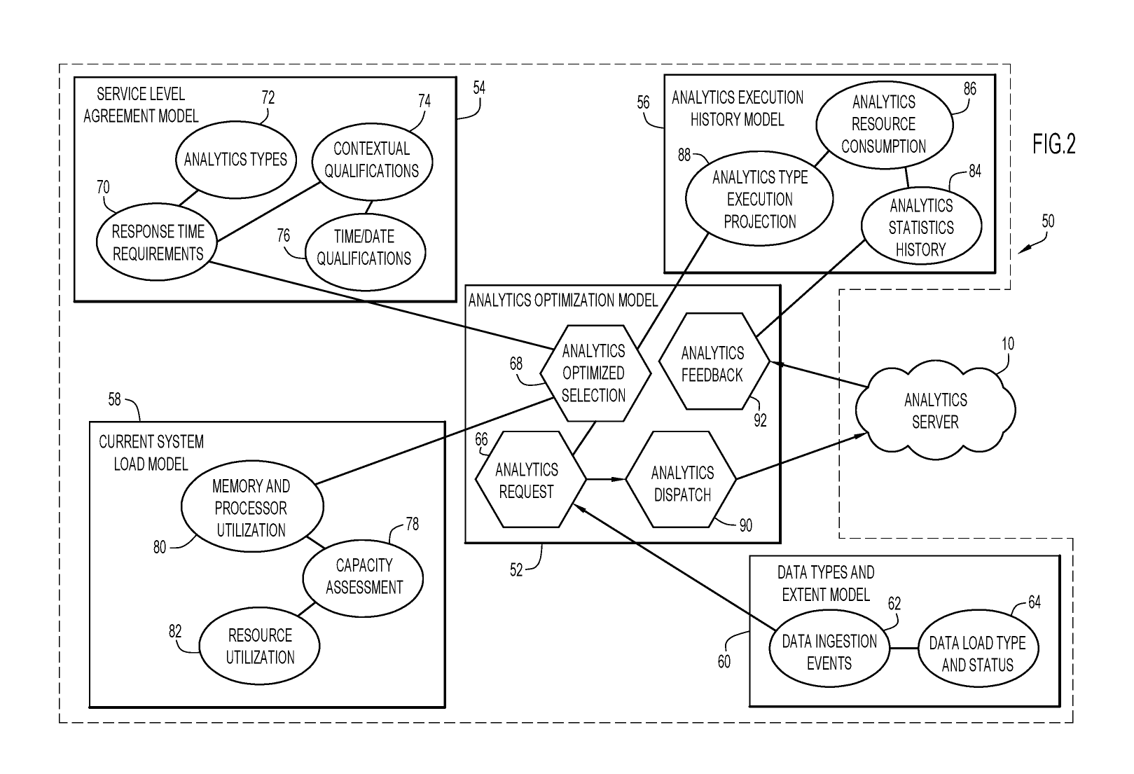

Optimization models 50 that may be used by server systems 10 to select fraud analytics according to an example embodiment are illustrated in FIG. 2. The optimization models 50 may include an analytics optimization model 52, a service level agreement (SLA) model 54, an analytics execution history model 56, a current system load model 58, and an operational data types and extent model 60. The models 50 may be executed on the same server or they may be executed on multiple servers, e.g., in a distributed manner.

The analytics optimization model 52 includes an analytics request function 66 that initiates a fraud analytics selection process in response to an analytics request (e.g., via data types and extent model 60 based on data ingestion events 62 and data load type/status 64 pertaining to a transaction), an analytics optimized selection function 68 that selects an optimal fraud analytic to evaluate the transaction (e.g., based on information from the service level agreement model 54, the analytics execution history model 56, and the current system load model 58), an analytics dispatch function 90 that sends the result of the fraud analytics selection process to the fraud detection server systems (e.g., for use by analysis module 26), and an analytics feedback function 92 that receives execution data (e.g., execution time and/or resources consumed) from the fraud detection server systems (e.g., from analysis module 26) pertaining to execution of the selected fraud analytic, and updates the analytics statistics history 84 and/or analytics resource consumption 86 in analytics execution history model 56.

The SLA model 54 provides information about the terms and conditions of specified service level agreements, such as response time requirements 70, specified types of fraud analytics 72, contextual qualifications 74 (e.g., rules based on type of transaction, location, and/or amount), and temporal qualifications 76 (e.g., rules based on date, time, and/or day of week) and any other qualifications that could affect the run time target.

The analytics execution history model 56 maintains current and historical statistics on analytics execution times 84, and analytics resource consumption 86. The model 56 may also be configured for analytics execution time estimation and projection 88, e.g., based on the execution times statistics 84.

The current system load model 58 provides information on the current utilization of system resources, such as memory and processor utilization 80 and utilization of system resources 82 such as network, disk, database, etc. The model 58 may also be configured to provide a real time capacity assessment 78, such as an indication of available memory capacity and/or available processor capacity. In an example embodiment, the current system load model 58 is configured to monitor the current utilization and/or capacity of system resources, e.g., using an agent on the runtime environment.

The operational data types and extent model 60 maintains information on business application data relating to a transaction. In an example embodiment, model 60 may be configured as a meta-data model that reflects information, such as data load type (e.g., credit card purchase, insurance claim, loan application, new bank account, etc.) and/or status (e.g., real time request, historical review) of business data 64 relating to a transaction as the data is loaded into the system. In an example embodiment, the data types and extent model 60 may initiate the analytics optimization process described herein in response to data ingestion events 62, such as submission of a transaction to a transaction server system 12 for processing (e.g., a credit card purchase) or submission of an analytics request from a client system 14 directly to a fraud detection server system 10 (e.g., a request for historical analysis).

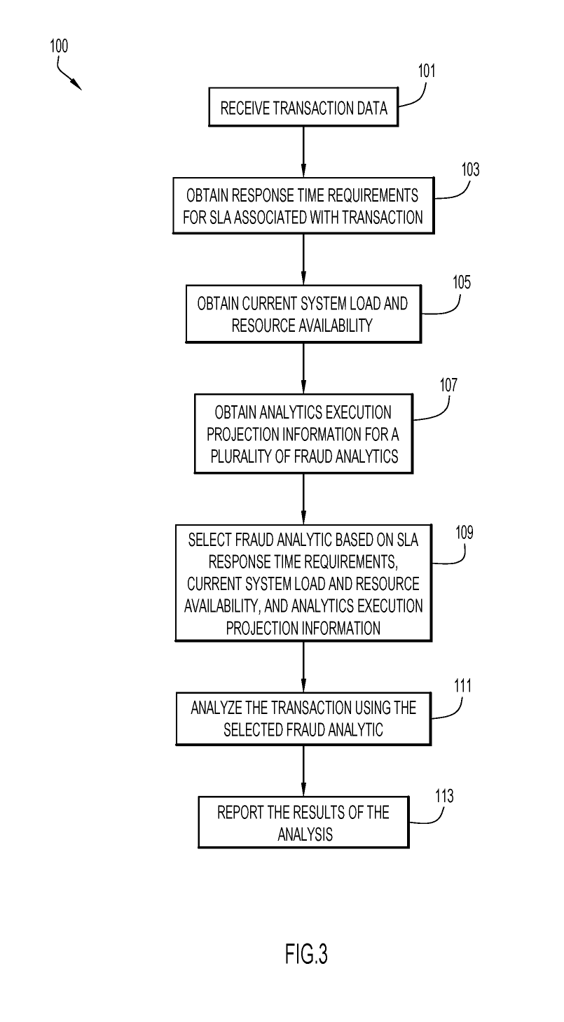

A manner of detecting a fraudulent transaction according to an example embodiment is illustrated in FIG. 3 at 100. Initially, transaction data is received at step 101 (e.g., via analytics optimization module 24 and at least one server system 10). For example, server system 10 may be configured to receive data about a transaction (e.g., data load type and status) from a transaction processing module 28 on a transaction server system 12 when a client system 14 submits a transaction for processing. In an example embodiment, the server system 10 receives transaction data in response to pre-defined data ingestion events, such as transmission of credit card transaction data (e.g., date, time, location, account number, and amount) to a transaction server system 12 over an electronic communications network. In an example embodiment, a data types and extent model (e.g., model 60) may include one or more rules that cause a fraud analytics request to be initiated based on data ingestion events and the type of data received, and the model may pass at least some of the transaction data to an analytics optimization model (e.g., model 52).

In step 103, response time requirements for the corresponding service level agreement are obtained (e.g., via analytics optimization module 24 and at least one server system 10). In an example embodiment, transaction data is passed from a data types and extent model (e.g., model 60) to a service level agreement model (e.g., model 54) that uses the data to determine response time requirements defined in the service level agreement corresponding to the transaction (e.g., the service level agreement with the client requesting the fraud analysis) and returns the response time requirements to an analytics optimization model (e.g., model 52). In an example embodiment, response time requirements may be subject to contextual qualifications (e.g., type of transaction, known or unknown device, international versus domestic, etc.) and/or time/date qualifications (e.g. day of the week, time of day, holiday, etc.). In an example embodiment, risk models specified in the service level agreement may be obtained (e.g., via a service level agreement model) along with response time requirements. For example, a pre-defined list of risk models or analytics that may be used for the transaction may be obtained based on the transaction data.

In step 105, current system load and resource availability are obtained (e.g., via system load monitoring module 25 and at least one server system 10). For example, module 25 may provide information on the current utilization of system resources, such as memory and processor utilization 80 and utilization of other system resources 82 such as network, disk, database, etc. The module 25 may also provide a real time capacity assessment 78, such as an indication of available memory capacity and/or available processor capacity. In an example embodiment, current utilization and/or capacity of system resource may be obtained by module 25 using an agent on the runtime environment. In an example embodiment, the information is passed by module 25 to the analytics optimization module 24.

In step 107, analytics execution projection information for a plurality of risk models are obtained (e.g., via analytics optimization module 24 and at least one server system 10). For example, projected or estimated execution times may be obtained for each of the fraud analytics defined in the SLA. In an example embodiment, the projected or estimated execution times may be determined based on analytics statistics history (e.g., via an analytics execution history model). The amount of system resources consumed by each of the fraud analytics may also be obtained in this step.

In step 109, a fraud analytic is selected from a plurality of available analytics based on SLA response time requirements, current system load and resource availability, and analytics execution projection information (e.g., via analytics optimization module 24 and at least one server system 10). In an example embodiment, an analytics optimization model (e.g., model 52) may be configured to select an optimal fraud analytic, e.g., the most accurate and complete (e.g., least risky) fraud analytic that is also compatible with the available data, that has a projected or estimated execution time in compliance with SLA response time requirements, and that uses no more than currently available system resources. For example, if there is an adequate amount of data and computing resources available to utilize a deterministic analytic, a scoring analytic, or a regression analytic, and the projected execution time for each analytic complies with SLA response time requirements, present invention embodiments may select the regression analytic to provide a more accurate and complete fraud analysis.

In step 111, the transaction is analyzed using the selected fraud analytic (e.g., via analysis module 26 and at least one server system 10). In an example embodiment, applying the selected fraud analytic to the transaction may result in a risk score (e.g., a quantitative value, such as a numerical score, and/or a qualitative value, such as low risk, medium risk, or high risk).

In step 113, the results of the fraud detection analysis may be reported to the transaction server system 12 (e.g., via analysis module 26 and at least one server system 10). For example, a risk score (e.g., quantitative and/or qualitative) may be reported to the transaction server. In another example embodiment, a risk score may be reported to a client system that requested the analysis. In yet another example embodiment, an electronic process may be initiated to cancel an electronic transaction on the basis of the results of the analysis.

In an example embodiment, the method may further include measuring (e.g., using an agent running on the computing environment) a service time and/or resource consumption associated with applying the selected fraud detection analytic to the first transaction, updating the historical data based on the measured service time and/or resource consumption, and updating the fraud detection analytics optimization model based on the updated historical data. The updated historical data may then be used when selecting an optimal fraud analytic to analyze a second transaction that occurs after the first transaction has been analyzed.

It will be appreciated that the embodiments described above and illustrated in the drawings represent only a few of the many ways of detecting fraud according to present invention embodiments. For example, instead of selecting an analytic that provides the most accurate and complete analysis within a specified response time, the optimization process may be configured to minimize response time and/or consumption of computing resources while providing an acceptable level of risk.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, modeling module, analysis module, etc.). These systems may include any types of monitors and input devices (e.g., keyboard, mouse, voice recognition, etc.) to enter and/or view information.

It is to be understood that the software (e.g., modules 24, 25, 26, 28, 30, etc.) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments (e.g., modules 24, 25, 26, 28, 30, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., analytics, analytics execution history data, SLA information, etc.). The database system may be implemented by any number of any conventional or other databases, data stores or storage structures (e.g., files, databases, data structures, data or other repositories, etc.) to store information (e.g., analytics, analytics execution history data, SLA information, etc.). The database system may be included within or coupled to the server and/or client systems. The database systems and/or storage structures may be remote from or local to the computer or other processing systems, and may store any desired data (e.g., analytics, analytics execution history data, SLA information, etc.).

The present invention embodiments may employ any number of any type of user interface (e.g., Graphical User Interface (GUI), command-line, prompt, etc.) for obtaining or providing information (e.g., transaction data, fraud analysis requests), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific transactions described above, but may be utilized to detect fraud associated with any type of transaction. Additionally, while an example embodiment including one or more transaction server systems is shown and described, it will be appreciated that present invention embodiments may be implemented in environments without transaction server systems. For example, a client system may initiate a fraud detection analysis by submitting a request directly to the fraud detection server systems.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for optimizing analytics selection to detect fraud comprising:
retrieving, from an electronic database, historical data on a plurality of available fraud detection analytics, the historical data including service times and risk levels associated with the fraud detection analytics;
analyzing the historical data to form a fraud detection analytics optimization model;
receiving, from a requester via an electronic communications network, a request to analyze a first transaction, the request including information about the first transaction;
determining, based on the requester and information about the first transaction, a required service time for the first transaction;
using the fraud detection analytics optimization model to select, from the plurality of available fraud detection analytics, a fraud detection analytic with a lowest risk level predicted to execute within the required service time;
applying the selected fraud detection analytic to the first transaction to obtain an indication of risk; and
reporting, to the requester via the electronic communications network, the indication of risk for the first transaction.

2. The method of claim 1, further comprising measuring a service time associated with applying the selected fraud detection analytic to the first transaction, updating the historical data based on the measured service time, and updating the fraud detection analytics optimization model based on the updated historical data.

3. The method of claim 1, further comprising retrieving, from an electronic database, a service level agreement model associated with the requester, and applying the service level agreement model to the first transaction to determine a required service time for the first transaction.

4. The method of claim 3, wherein the service level agreement model is configured to determine one of a plurality of required service times for a transaction based on temporal qualifications.

5. The method of claim 3, wherein the service level agreement model is configured to determine one of a plurality of required service times for a transaction based on contextual qualifications.

6. The method of claim 1, further comprising retrieving, from an electronic database, a service level agreement model associated with the requester, and applying the service level agreement model to the first transaction to determine the plurality of available fraud detection analytics.

7. The method of claim 1, wherein the historical data further includes resource consumption associated with the fraud detection analytics, and wherein the fraud detection analytics optimization model is configured to take into account the historical data on resource consumption and current system resources when selecting a fraud detection analytic for the first transaction.

8. A system for optimizing analytics selection to detect fraud, comprising:
at least one processor configured to:
retrieve, from an electronic database, historical data on a plurality of available fraud detection analytics, the historical data including service times and risk levels associated with the fraud detection analytics;
analyze the historical data to form a fraud detection analytics optimization model;
receive, from a requester via an electronic communications network, a request to analyze a first transaction, the request including information about the first transaction;
determine, based on the requester and information about the first transaction, a required service time for the first transaction;
use the fraud detection analytics optimization model to select, from the plurality of available fraud detection analytics, a fraud detection analytic with a lowest risk level predicted to execute within the required service time;
apply the selected fraud detection analytic to the first transaction to obtain an indication of risk; and
report, to the requester via the electronic communications network, the indication of risk for the first transaction.

9. The system of claim 8, wherein the processor is configured to measure a service time associated with applying the selected fraud detection analytic to the first transaction, to update the historical data based on the measured service time, and to update the fraud detection analytics optimization model based on the updated historical data.

10. The system of claim 8, wherein the processor is configured to retrieve, from an electronic database, a service level agreement model associated with the requester, and to apply the service level agreement model to the first transaction to determine a required service time for the first transaction.

11. The system of claim 10, wherein the service level agreement model is configured to determine one of a plurality of required service times for a transaction based on temporal qualifications.

12. The system of claim 10, wherein the service level agreement model is configured to determine one of a plurality of required service times for a transaction based on contextual qualifications.

13. The system of claim 8, wherein the processor is configured to retrieve, from an electronic database, a service level agreement model associated with the requester, and to apply the service level agreement model to the first transaction to determine the plurality of available fraud detection analytics.

14. The system of claim 8, wherein the historical data further includes resource consumption associated with the fraud detection analytics, and wherein the fraud detection analytics optimization model is configured to take into account the historical data on resource consumption and current system resources when selecting a fraud detection analytic for the first transaction.

15. A computer program product for optimizing analytics selection to detect fraud, the computer program product comprising a computer readable storage medium having program instructions embodied therewith, the program instructions executable by a computer processor to cause the computer processor to:
retrieve, from an electronic database, historical data on a plurality of available fraud detection analytics, the historical data including service times and risk levels associated with the fraud detection analytics;
analyze the historical data to form a fraud detection analytics optimization model;
receive, from a requester via an electronic communications network, a request to analyze a first transaction, the request including information about the first transaction;
determine, based on the requester and information about the first transaction, a required service time for the first transaction;
use the fraud detection analytics optimization model to select, from the plurality of available fraud detection analytics, a fraud detection analytic with a lowest risk level predicted to execute within the required service time;
apply the selected fraud detection analytic to the first transaction to obtain an indication of risk; and
report, to the requester via the electronic communications network, the indication of risk for the first transaction.

16. The computer program product of claim 15, wherein the program instructions are executable by a computer processor to cause the computer processor to measure a service time associated with applying the selected fraud detection analytic to the first transaction, to update the historical data based on the measured service time, and to update the fraud detection analytics optimization model based on the updated historical data.

17. The computer program product of claim 15, wherein the program instructions are executable by a computer processor to cause the computer processor to retrieve, from an electronic database, a service level agreement model associated with the requester, and to apply the service level agreement model to the first transaction to determine a required service time for the first transaction.

18. The computer program product of claim 17, wherein the program instructions are executable by a computer processor to cause the computer processor to determine one of a plurality of required service times for a transaction based on one or more of the group comprising temporal and contextual qualifications.

19. The computer program product of claim 15, wherein the program instructions are executable by a computer processor to cause the computer processor to retrieve, from an electronic database, a service level agreement model associated with the requester, and to apply the service level agreement model to the first transaction to determine the plurality of available fraud detection analytics.

20. The computer program product of claim 15, wherein the historical data further includes resource consumption associated with the fraud detection analytics, and wherein the fraud detection analytics optimization model is configured to take into account the historical data on resource consumption and current system resources when selecting a fraud detection analytic for the first transaction.
